(19) United States
(12) Patent Application Publication
(10) Pub. No.: US 2022/0101002 A1
(43) Pub. Date: Mar. 31, 2022

(54) REAL-WORLD OBJECT INCLUSION IN A VIRTUAL REALITY EXPERIENCE

(71) Applicant: KYNDRYL, INC., NEW YORK, NY (US)

(72) Inventors: Todd Russell Whitman, Bethany, CT (US); Jeremy R. Fox, Georgetown, TX (US); Zachary A. Silverstein, Jacksonville, FL (US); Sarbajit K. Rakshit, Kolkata (IN)

(21) Appl. No.: 17/039,695

(22) Filed: Sep. 30, 2020

(51) Int. Cl. G06K 9/00; G06T 7/73; G06T 7/00; G06T 19/00

(52) U.S. Cl. CPC G06K 9/00671; G06T 19/006; G06T 7/97; G06T 7/73

(57) ABSTRACT

A method of generating a virtual reality (“VR”) experience includes recognizing a real-world (“RW”) object in possession of a user of the VR experience, and defining a VR object that corresponds to the RW object, wherein the VR object is configured to be used during the VR experience. The method also includes tracking the RW object to identify actions related to with the RW object, and rendering the VR object in the VR experience to correspond with the actions related to the RW object.

### BACKGROUND

The present invention relates to generating a virtual reality (“VR”) experience, and more specifically, to including real-world (“RW”) objects in the VR experience.

VR experiences can involve a user immersing themselves in a fully virtualized environment. VR can be an extremely entertaining experience for the user, although it can isolate the user from many physical, RW objects. This can prevent the user from using RW objects, such as a smartphone, during the VR experience.

### SUMMARY

According to an embodiment of the present disclosure, a method of generating a VR experience includes recognizing a RW object in possession of a user of the VR experience, and defining a VR object that corresponds to the RW object, wherein the VR object is configured to be used during the VR experience. The method also includes tracking the RW object to identify actions related to with the RW object, and rendering the VR object in the VR experience to correspond with the actions related to the RW object.

According to an embodiment of the present disclosure, a VR system includes a VR controller including one or more processors and a computer-readable storage medium coupled to the one or more processors storing program instructions, the VR controller being configured to generate a VR experience, a VR headset communicatively connected to the VR controller that is configured to display a VR space to a user, a sensor communicatively connected to the VR controller that is configured to monitor a spectator space proximate to the user, and a display communicatively connected to the VR controller that is viewable from the spectator space. The program instructions, when executed by the one or more processors, cause the one or more processors to perform operations including recognizing a RW object in possession of a user of the VR experience, defining a VR object that corresponds to the RW object, wherein the VR object is configured to be used during the VR experience, tracking the RW object to identify actions related to with the RW object, and rendering the VR object in the VR experience to correspond with the actions related to the RW object.

According to an embodiment of the present disclosure, a method of generating a VR experience includes recognizing a RW object in possession of a user of the VR experience, and defining a VR object that corresponds to the RW object, wherein the VR object is configured to be used during the VR experience. The method also includes tracking the RW object to identify position of the RW object with respect to a user of the VR experience, and rendering the VR object in the VR experience in accordance with a context of the VR experience and the position of the RW object with respect to the user such that the VR object appears different than the RW object.

### BRIEF DESCRIPTION OF THE DRAWINGS

FIG. 1 shows a VR system with a user with a smartphone and a pen, in accordance with one embodiment of the present disclosure.

FIG. 2 shows a view of a VR space, in accordance with one embodiment of the present disclosure.

FIG. 3 shows a flowchart of a method of generating a VR experience, in accordance with one embodiment of the present disclosure.

FIG. 4 shows a high-level block diagram of an example computer system that can be used in implementing embodiments of the present disclosure.

FIG. 5 shows a cloud computing environment, in accordance with an embodiment of the present disclosure.

FIG. 6 shows abstraction model layers, in accordance with an embodiment of the present disclosure.

### DETAILED DESCRIPTION

The present disclosure presents a system and method wherein RW objects can be included in a VR experience. In some embodiments, a VR user can selectively define one or more real world objects which can be used while navigating a VR space. The VR system can selectively recognize the RW objects and can allow the user to view the RW objects within the VR space. In some embodiments, the appearance and content of the RW objects can be aligned with the context of the VR content navigation. By allowing the inclusion of RW objects to be dynamic and selective in nature, there can be a greater integration of the RW environment into the VR experience.

This can be useful because, in many situations, a user might want or need to use RW objects, such as a smartphone, smartwatch, writing instrument, or security system, while navigating VR content. The use of RW objects while navigating VR content can make the VR experience more realistic for the user and/or allow the user to manage RW tasks without exiting from the VR experience.

While navigating VR content, artificial intelligence (“AI”) in the VR system can learn and recognize personal behaviors and habits of the user with respect to RW objects. This information can be used to construct a VR experience that incorporates the RW objects and allows for control thereof. For example, a user can take out their RW smartphone from their pocket, and the VR system can render the smartphone in the VR experience, including its graphical user interface (“GUI”). This allows the user to access the functions of the smartphone because the RW device is integrated into the VR environment. In some embodiments, the user can use the smartphone to capture a photograph of the VR content or determine the speed of movement of the user through the VR space. Furthermore, actions that are taken in the VR experience can be pushed to the RW device. For one example, the photograph that was taken by the smartphone within the VR experience can be sent to the RW smartphone for viewing outside of the VR experience. For another example, a text message received by the smartphone can be displayed in the VR space, and the user can use the rendered smartphone to respond to it. Thus, the other party can receive a response to their original message without requiring the user to exit the VR experience.

Because the RW object can be paired with the VR system, the content and/or appearance of the RW object can be influenced by the context of the VR space. For example, if the user is traveling at a certain location at a certain speed in the VR experience, then if the user opens the map application on their smartphone, the location and speed shown can reflect what is happening in the VR experience (even if the user is at a different location or traveling a different or null speed). In addition, if the user is holding a flashlight and a ballpoint pen, for example, but the context of the game is in the 18^{th} century, the flashlight can be rendered as an oil lantern and the ballpoint pen can be rendered as a feather quill pen. Conversely, when the user turns on the flashlight, the external cameras of the VR system can see the beam and render the beam in the VR space. Thereby, the RW objects and the VR system exist in a created ecosystem created by their pairing.

In order to incorporate RW objects into a VR experience, the user can selectively identify which RW devices are to be used during VR content navigation. In the case of devices that can contain personal data (e.g., a smartphone), the user can “opt-in” to allow the VR system to access their device. In such situations, the VR system may only use data that is specifically relevant to incorporating the device into the VR experience. The RW devices that are selected can be stored in a database that can also be populated with generic items. Thereby, the user can associate their RW devices with a generic item, or custom profiles can be created for the RW devices. The database, for example, can also include associated identifying information for the RW devices (e.g., what each one looks like), the name/make/model of each RW device, communication information for each smart device, physical properties of each RW devices (e.g., for use by a physics engine), what types of actions can be performed using each device, and information for how each RW device should appear and/or function in certain VR contexts, among other things.

During the VR experience, the VR system can use external cameras to identify the RW devices that the user is interacting with during the VR experience. The VR system can present the devices in the field of view (“FOV”) of the user if the devices would be in the user's FOV. The VR system can also render the devices as they are or as the user selects them to be. In addition, the rendered devices can be influenced by the context of the VR space. For example, a wristwatch can be rendered to state the time in the VR space, regardless of what the watch says or what the RW time is. This can also occur in the case of a smartwatch, although, in some embodiments, the VR system can instruct a smartwatch to display the VR space time instead of the actual time. Then, the VR system can render the smartwatch as it is in the RW since it is already displaying the time of the VR space. The VR system can further render any reactions that the devices have to the user's interactions in real-time, just as though the user is interacting with them in the RW. For example, if the user turns on the flashlight function of their smartphone, the beam of light will be rendered therefrom. However, in some embodiments, the VR system will communicate with the smartphone instructing the smartphone to not actually turn the flashlight on. This is done to conserve power and because the RW flashlight would not be useful to the user, who is wearing a VR headset over their eyes.

In some situations, a user may desire to use their RW device in such a manner that is outside of the context of the VR experience. For example, a person in physical proximity may want to show the user a RW thing. In this situation, using a verbal command or other input device/method, the VR system can switch the use of the device from VR mode to normal mode. With this capability, the user can take a picture using their smartphone and the picture will be of the real world, not of the VR space. Then, once the VR system renders the GUI of the smartphone in the VR space, the user can look at the RW thing without removing the VR headset. Then, the user can command the VR system to switch the use of the device back to VR mode, or to another mode such as augmented reality (“AR”) mode or mixed reality (“MR”) mode.

Furthermore, in a collaborative environment, multiple users can navigate the same VR space (using separate but connected VR systems), and their actions can be aggregated. For example, if a user is using a flashlight, the beam of light can be rendered in the VR space. Thereby, the light can be viewable to the other users in the VR space.

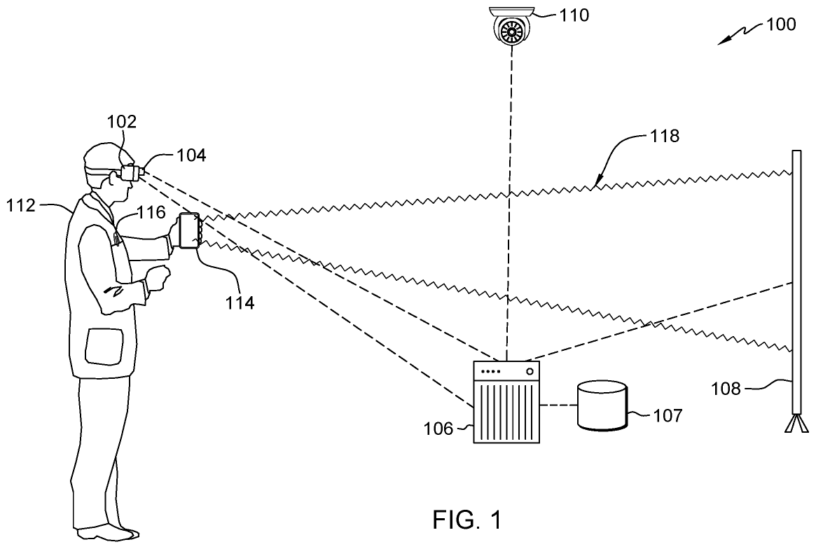

Referring now to the Figures, FIG. 1 shows VR system 100 which comprises VR headset 102, headset camera 104, VR controller 106 (with object database 107), display device 108, and ceiling-mounted camera 110. These components of VR system 100 are wirelessly connected together to provide a VR experience for user 112 who is wearing VR headset 102. In addition, display device 108 can show various portions of the VR experience (e.g., the view that user 112 is seeing) to allow other people (not shown) to see the VR experience. It is to be understood that one or more of the components depicted in FIG. 1 can be omitted or replaced in other embodiments. For example, in some embodiments, display device 108 is omitted.

In the illustrated embodiment, cameras 104 and/or 110 monitor RW objects in possession of user 112 (i.e., objects around, in contact with, in control of, on the person of, and/or held by user 112). Cameras 104 and/or 110 can include additional sensors, such as microphones. The information from cameras 104 and 110 can be sent to and analyzed by VR controller 106. VR controller 106 can detect, identify, and monitor the RW objects, which can include, for example, RW smartphone 114, RW pen 116, and RW light beam 118. In some embodiments, the detection, identification, and/or monitoring of RW objects occurs by optical machine vision via cameras 104 and/or 110.

If VR controller 106 determines that user 112 is using a RW object, then VR controller 106 can prompt user 112 to opt-in to the VR experience, which allows VR system 100 to recognize and incorporate the RW object into the VR experience. While this step may not be as relevant when dealing with a nonconnected devices (i.e., devices that lack electronic communication capability, like a ballpoint pen), this step has more significance when the RW object is an Internet-connected or Internet of Things (“IOT”) device and/or when the RW object may include personal data (e.g., RW smartphone 214). User 112 can opt-in, for example, using display device 108 and/or cameras 104 and/or 110. This opt-in can also be limited as to what information and content is available to VR system 100.

Once user 112 has opted in, then VR controller 106 can analyze the RW object using object database 107. Object database 107 can include information to identify different RW objects (e.g., name, make, model, color, and shape). Object database 107 can have entries for a variety of different generic objects (e.g., a pen, a flashlight, or a spoon) as well as specific objects that can be customized by user 112 (e.g., a short handle that user 112 wants to be representative of a tennis racket). The identifying information of each RW object can be coupled with physical information (e.g., physics-related information) about each RW object (e.g., size, weight, and flexibility); information about how each RW object should be rendered by VR headset 102 (e.g., size and color), for example, as they exist in the real world or as they should exist with respect to the context of the VR experience; and information about how each RW object should behave in the VR experience (e.g., weight and flexibility), for example, with respect to the physics engine of the VR experience.

Thereby, VR system 100 can positively identify RW objects being used by user 112 as well as monitor how they are acting or acted upon (e.g., being used and/or moved) by user 112 in the real world. Then, the properties (or assigned properties) and use of a RW object can be applied to a VR object, so that the VR object that corresponds to the RW object, for example, with respect to actions taken by user 112 on the RW object. This can improve the VR experience because the user can feel a desired RW object in their hands during the VR experience instead of merely using a dedicated component of VR system 100 (e.g., a game controller or other generic input device).

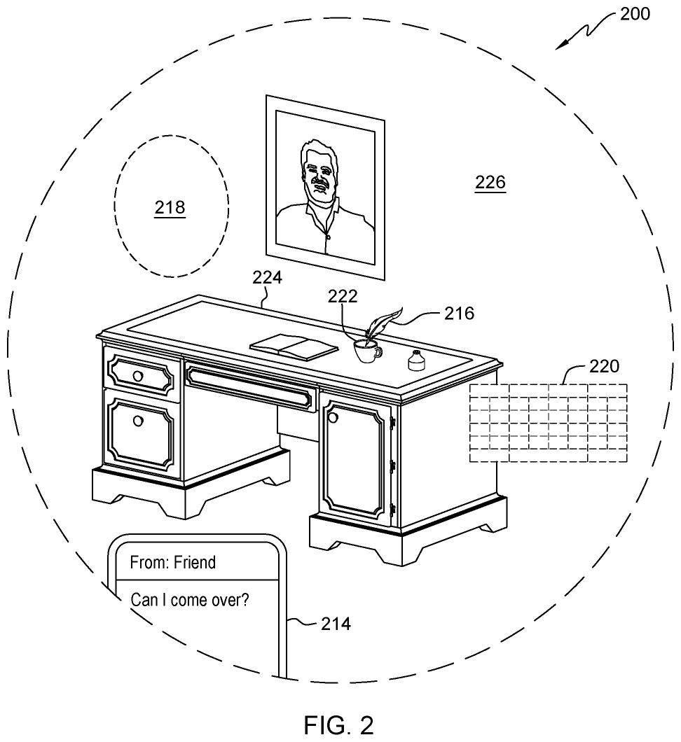

FIG. 2 shows an example VR view 200 of the VR space, for example, from the inside of VR headset 102 as user 112 would see it. VR view 200 includes VR smartphone 214, VR pen 216, VR light beam 218, VR keyboard 220, cup 222, and desk 224. Because VR view 200 takes place in the greater context of the real world (shown in FIG. 1), references may be made to the features of FIG. 1.

In the illustrated embodiment, VR system 100 is rendering VR pen 216 and VR light beam 218 because VR system 100 has recognized and is observing RW pen 116 and RW light beam 118 proximate to user 112. More specifically, camera 110 can see RW pen 116 in the pocket of user 112, which is why VR pen 216 is shown in cup 222 on desk 224 (as opposed to being shown in the hand of user 112 in VR view 200). In addition, cameras 104 and 110 can see RW light beam 118 emerging forward from RW smartphone 114, which is why VR light beam 218 is shown projected onto wall 226. Thereby, RW pen 116 and VR pen 216 are paired by optical recognition, and RW light beam 118 and VR light beam 118 are also paired by optical recognition.

Because RW light beam 118 is a natural optical effect, it can be recognized by VR system 100 because object database 107 can be pre-configured with a set of generic objects. On the other hand, RW pen 116 has a less specific shape to it, so user 112 could have trained VR system 100 what RW pen 116 is. In some embodiments, the training process can entail holding RW pen 116 in front of headset camera 104 and communicating what RW pen 116 is or should be using an input device, such as, for example, voice commands or VR keyboard 220. In some embodiments, training can occur when VR system 100 is not being operated, for example, by user 112 interacting directly with object database 107 using still images and/or text to assign or create object profiles.

In some cases, user 112 would instruct VR system 100 that RW pen 116 should be recognized as a ballpoint pen, so RW pen 116 could be recognized as having the properties of the ballpoint pen that has been pre-programmed into object database 107, and the rendering of VR pen 216 would have the same appearance as RW pen 116. In other cases, user 112 would instruct VR system 100 that RW pen 116 should have a custom profile, and then user 112 could set forth what the properties of VR pen 216 should be. In such cases, VR pen 216 would have properties that would be different from and/or untrue of RW pen 116. For example, VR pen 216 could have been rendered as a feather quill pen because user 112 instructed VR system 100 to do so. However, VR pen 216 could have been rendered as a feather quill pen because user 112 instructed VR system 100 that RW pen 116 is a generic ballpoint pen, but the context of the VR experience (e.g., set in the 18^{th} century) could have dictated that a generic ballpoint pen should be rendered as a feather quill pen to avoid anachronisms.

As opposed to VR pen 116, VR system 100 is rendering VR smartphone 214 close to the face of user 112 (as though it is in the hand of user 112) in VR view 200 because VR system 100 has recognized and is observing RW smartphone 114 in the hand of user 112. While RW smartphone 114 and VR smartphone 214 are paired by optical recognition, RW smartphone 114 and VR smartphone 214 are also communicatively paired. In some embodiments, RW smartphone 114 and VR controller 106 both include a computer application that allows communication, sharing, and/or control therebetween (“CSC application”). In some embodiments, the communication is achieved via near field communication (“NFC”), Wi-Fi, Bluetooth®, cellular service, and/or the Internet.

The communicative pairing between an electronically communicative device (e.g., an IOT device, such as RW smartphone 114) and its virtual counterpart (such as VR smartphone 214) allows for the use of functions of RW smartphone 114 in the VR experience. For example, communications (e.g., texts, voice calls, and video calls) and applications (e.g., flashlights, alarms, and maps) can be interacted with in the VR experience using VR smartphone 214 without exiting the VR experience.

In some embodiments, when communicating through RW smartphone 114 using VR smartphone 214, a prompt (e.g., an incoming text message) from RW smartphone 114 can by recognized by VR system 100 through either optical observance of the GUI of RW smartphone 114 (e.g., by headset camera 104) or through the CSC application. Then, the GUI of VR smartphone 214 can be rendered to display the prompt and/or the communication itself. In some embodiments, in order to respond, user 112 can use their input device (e.g., their fingers or a stylus) as normal on RW smartphone 114, with the input device and the response communication (if there is a visual component thereto) being rendered on VR smartphone 214. In some embodiments, in order to respond, VR system 100 will render a VR response interface (e.g., VR keyboard 220) in VR view 200. Then user 112 can use their input device to interact with the VR response interface, and the response communication (if there is a visual component thereto) can be rendered on VR smartphone 214 and/or in the VR response interface. When user 112 desires to send the response, VR system 100 will communicate the response to RW smartphone 114 via the CSC application or another method of electronic communication. Then, RW smartphone 114 can execute its native communication system/protocol to respond. Because the communication responses are routed through RW smartphone 114, VR system 100 does not require any further connectivity (e.g., Internet access) than communication with RW smartphone 114. Furthermore, the communication can occur in real-time and the responses would appear normal to the third party.

In some embodiments, when using applications of RW smartphone 114 using VR smartphone 214, the applications can be altered to fit in the context of the VR experience. For example, if the VR experience involves high speed travel in an imaginary location, then a mapping application on VR smartphone 214 can reflect the speed and location of user 112 in the VR experience as opposed to their actual speed (or lack thereof) and location. In some embodiments, this is accomplished by the CSC application instructing RW smartphone 114 to display in its GUI the information that is representative of the VR experience. Then, VR smartphone 214 will be rendered to correspond with RW smartphone 114. In other embodiments, this is accomplished by VR controller 106 rendering VR smartphone 214 with the information that is representative of the VR experience. In such embodiments, the GUI of VR smartphone 214 would not reflect or align with the GUI of RW smartphone 114.

As stated previously, VR light beam 218 can be rendered if VR system 100 detects RW light beam 118 from RW smartphone 114. However, in some embodiments, VR light beam 218 can be rendered based on the CSC application. In such embodiments, user 112 can turn on the flashlight on RW smartphone 114, for example, by touching the icon on RW smartphone 114. VR system 100 can observe the command to turn on the flashlight and render VR light beam 218 based on the position and orientation of RW smartphone 114. However, VR system 100 can communicate through the CSC application to not actually turn on the flashlight, which prevents RW smartphone 114 from creating RW light beam 118. This conserves the electrical power of RW smartphone 114 and does not affect user 112 since user 112 could not see RW light beam 118 due to VR headset 102. Furthermore, the CSC application can be shared amongst any other users (not shown) in the same VR experience as user 112. This allows the other VR systems (not shown) to render VR light beam 218 in their VR views as it is projected from VR smartphone 214.

In addition, if user 112 takes a picture using RW smartphone 114, VR system 100 can virtually take a picture or video inside of the VR experience from the perspective of VR smartphone 214. This VR content can be sent to RW smartphone 114 via the CSC application and take the place of the content that was actually recorded (or be saved where that content would be, in case the CSC application prevented RW smartphone 114 from recording content in the first place). Thereby, user 112 can save content from the VR experience, for example, to share with others who are not watching display device 108. However, in case user 112 desires to see the RW, user 112 can selectively disable this function and take a picture using RW smartphone 114. Then, VR system 100 can render this picture, for example, in the GUI of VR smartphone 214 (as it appears in the GUI of RW smartphone 114). Thereby, user 112 can see what is actually proximate to themselves without needing to remove VR headset 102 and disengage from the VR experience.

The optical recognition pairing discussed previously allows for one-way engagement by RW objects. More specifically, actions on RW objects can be applied to VR objects. On the other hand, the communicative pairing of a RW object and a VR object, for example, using the CSC application allows for two-way engagement by RW objects and VR objects. More specifically, actions on RW objects can be applied to VR objects, and actions on VR objects can be applied to RW objects.

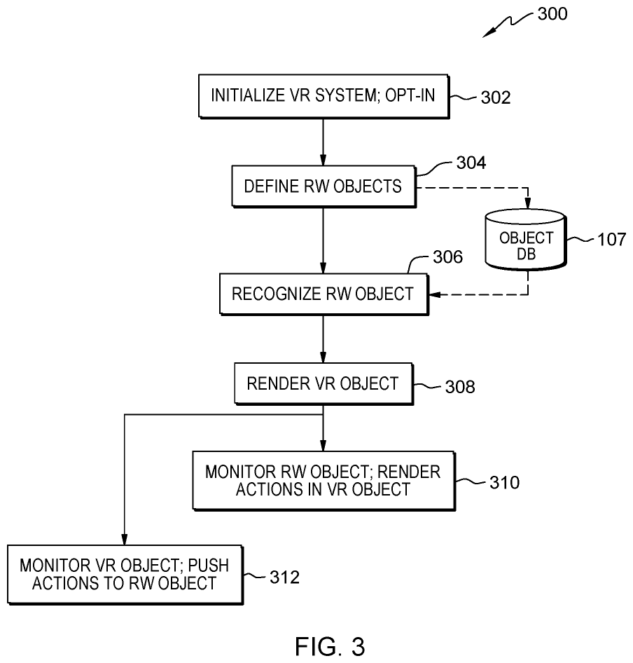

FIG. 3 shows a flowchart of method 300 of generating a VR experience. During the discussion of method 300, references may be made to the features of FIGS. 1 and 2. In the illustrated embodiment, at block 302, user 112 initializes VR system 100 and opts-in to pairing RW objects with VR objects in the VR experience. At block 304, VR system 100 can be trained by user 112 defining RW objects that can be stored, for example, in object database 107. At block 306, VR system 100 can recognize RW objects in proximity and/or use by user 112 (e.g., RW smartphone 114 and RW pen 116). Block 306 can occur using, for example, the information in object database 107. At block 308, the RW objects can be rendered in the VR experience as appropriate (e.g., whether in their RW forms or in other VR forms).

At block 310, VR system 100 monitors the RW objects and renders the paired VR objects according to the actions that user 112 performs with the RW objects (e.g., physical movements). In addition, at block 312, VR system 100 monitors the VR objects and pushes actions to the paired RW objects according to the actions that user 112 performs with the VR objects (e.g., sending pictures taken of the VR experience). Blocks 310 and 312 can occur until the VR experience ends, and blocks 304, 306, and 308 can occur as needed, for example, if user 112 introduces a new RW object.

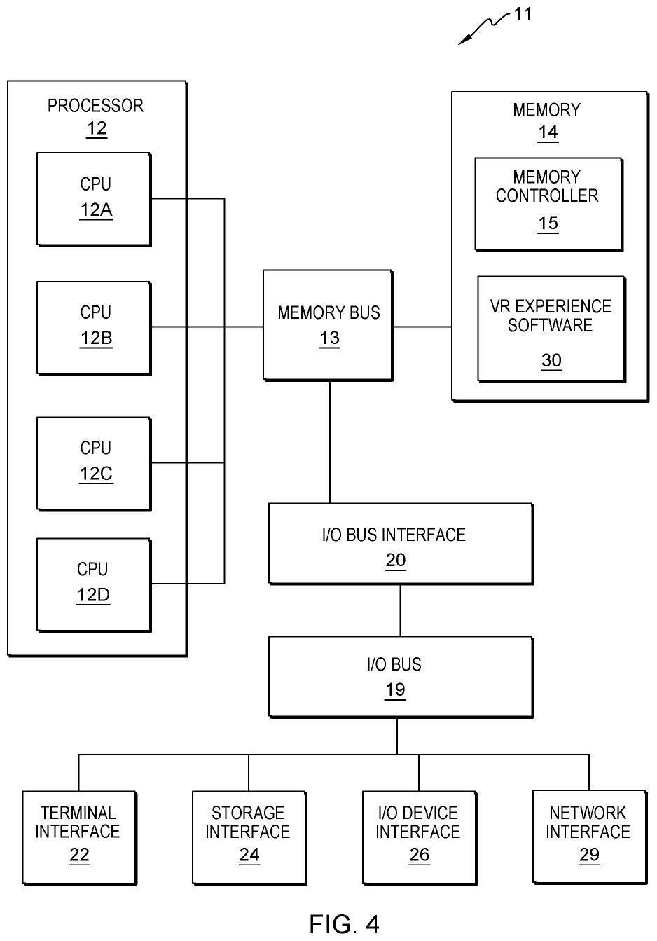

Referring now to FIG. 4, shown is a high-level block diagram of an example computer system (i.e., computer) 11 that may be used in implementing one or more of the methods or modules, and any related functions or operations, described herein (e.g., using one or more processor circuits or computer processors of the computer), in accordance with embodiments of the present disclosure. For example, computer system 11 can be used for VR headset 102, VR controller 106, display device 108, and RW smartphone 114 (shown in FIG. 1). In some embodiments, the components of the computer system 11 may comprise one or more CPUs 12, a memory subsystem 14, a terminal interface 22, a storage interface 24, an I/O (Input/Output) device interface 26, and a network interface 29, all of which may be communicatively coupled, directly or indirectly, for inter-component communication via a memory bus 13, an I/O bus 19, and an I/O bus interface unit 20.

The computer system 11 may contain one or more general-purpose programmable central processing units (CPUs) 12A, 12B, 12C, and 12D, herein generically referred to as the processer 12. In some embodiments, the computer system 11 may contain multiple processors typical of a relatively large system; however, in other embodiments the computer system 11 may alternatively be a single CPU system. Each CPU 12 may execute instructions stored in the memory subsystem 14 and may comprise one or more levels of on-board cache.

In some embodiments, the memory subsystem 14 may comprise a random-access semiconductor memory, storage device, or storage medium (either volatile or non-volatile) for storing data and programs. In some embodiments, the memory subsystem 14 may represent the entire virtual memory of the computer system 11 and may also include the virtual memory of other computer systems coupled to the computer system 11 or connected via a network. The memory subsystem 14 may be conceptually a single monolithic entity, but, in some embodiments, the memory subsystem 14 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 14 may contain elements for control and flow of memory used by the processor 12. This may include a memory controller 15.

Although the memory bus 13 is shown in FIG. 4 as a single bus structure providing a direct communication path among the CPUs 12, the memory subsystem 14, and the I/O bus interface 20, the memory bus 13 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 20 and the I/O bus 19 are shown as single respective units, the computer system 11 may, in some embodiments, contain multiple I/O bus interface units 20, multiple I/O buses 19, or both. Further, while multiple I/O interface units are shown, which separate the I/O bus 19 from various communications paths running to the various I/O devices, in other embodiments some or all of the I/O devices may be connected directly to one or more system I/O buses.

In some embodiments, the computer system 11 may be a multi-user mainframe computer system, a single-user system, or a server computer or similar device that has little or no direct user interface but receives requests from other computer systems (clients). Further, in some embodiments, the computer system 11 may be implemented as a desktop computer, portable computer, laptop or notebook computer, tablet computer, pocket computer, telephone, smart phone, mobile device, or any other appropriate type of electronic device.

In the illustrated embodiment, memory subsystem 14 further includes VR experience software 30. The execution of VR experience software 30 enables computer system 11 to perform one or more of the functions described above in operating a VR experience, including recognizing and monitoring RW objects and rendering VR objects in the VR space if appropriate (for example, blocks 302-312 shown in FIG. 3).

It is noted that FIG. 4 is intended to depict representative components of an exemplary computer system 11. In some embodiments, however, individual components may have greater or lesser complexity than as represented in FIG. 4, components other than or in addition to those shown in FIG. 4 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

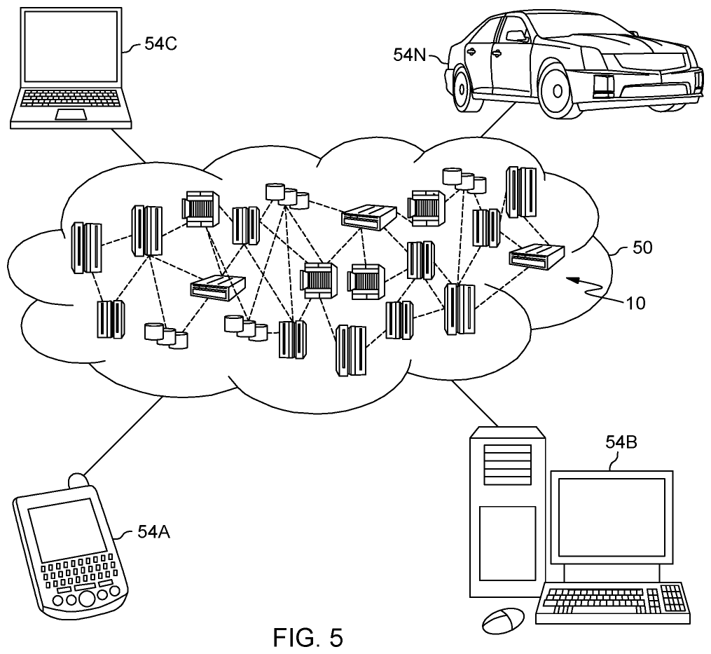

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

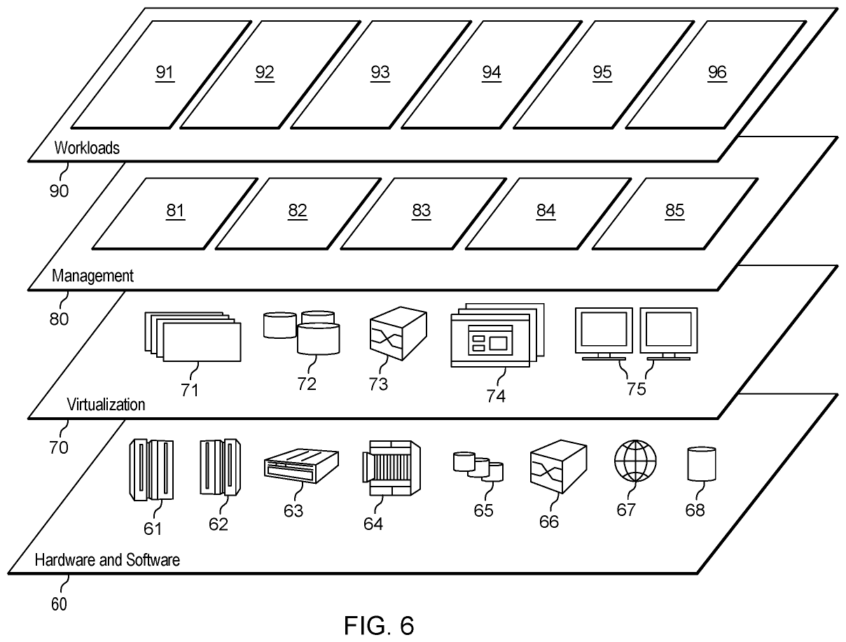

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. s depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and VR experience operation 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of generating a virtual reality (“VR”) experience, the method comprising:
recognizing a real-world (“RW”) object in possession of a user of the VR experience;
defining a VR object that corresponds to the RW object, wherein the VR object is configured to be used during the VR experience;
tracking the RW object to identify actions related to with the RW object; and
rendering the VR object in the VR experience to correspond with the actions related to the RW object.

2. The method of claim 1, further comprising:
defining properties of the RW object; and
reflecting the properties of the RW object in properties of the VR object.

3. The method of claim 1, wherein the actions related to the RW object comprise motions of the RW object by the user.

4. The method of claim 1, wherein the actions related to the RW object comprise a communication to or from the RW object.

5. The method of claim 1, wherein recognizing the RW object and tracking the RW object comprises:
using machine vision to analyze the RW object.

6. The method of claim 1, wherein recognizing the RW object comprises:
communicatively connecting with the RW object using a computer application.

7. The method of claim 6, wherein tracking the RW object comprises:
communicating electronically with the RW object.

8. The method of claim 7, further comprising:
sending content originating in the VR experience to the RW object.

9. The method of claim 7, further comprising:
instructing the RW object to display content that aligns with the content of the VR experience.

10. The method of claim 1, wherein:
the VR experience is generated by a VR system; and
the RW object is not a dedicated component of the VR system.

11. The method of claim 1, wherein the RW object lacks electronic communication capability.

12. A virtual reality (“VR”) system comprising:
a VR controller including one or more processors and a computer-readable storage medium coupled to the one or more processors storing program instructions, the VR controller being configured to generate a VR experience; and
a VR headset communicatively connected to the VR controller that is configured to display a VR space to a user;
wherein the program instructions, when executed by the one or more processors, cause the one or more processors to perform operations comprising:
recognizing a real-world (“RW”) object in possession of a user of the VR experience;
defining a VR object that corresponds to the RW object, wherein the VR object is configured to be used during the VR experience;
tracking the RW object to identify actions related to with the RW object; and
rendering the VR object in the VR experience to correspond with the actions related to the RW object.

13. The VR system of claim 12, wherein the RW object is not a dedicated component of the VR system.

14. The VR system of claim 12, wherein the RW object lacks electronic communication capability.

15. A method of generating a virtual reality (“VR”) experience, the method comprising:
recognizing a real-world (“RW”) object in possession of a user of the VR experience;
defining a VR object that corresponds to the RW object, wherein the VR object is configured to be used during the VR experience;
tracking the RW object to identify position of the RW object with respect to a user of the VR experience; and
rendering the VR object in the VR experience in accordance with a context of the VR experience and the position of the RW object with respect to the user such that the VR object appears different than the RW object.

16. The method of claim 15, wherein:
the VR experience is generated by a VR system; and
the RW object is not a dedicated component of the VR system.

17. The method of claim 15, wherein rendering the VR object according to a context of the VR experience comprises:
rendering a graphical user interface of the VR object to reflect the context of the VR experience instead of reflecting content of a graphical user interface of the RW object.

18. The method of claim 15, wherein rendering the VR object according to a context of the VR experience comprises:
assigning physics-related properties to the VR object that are untrue for the RW object.

19. The method of claim 15, wherein recognizing the RW object comprises:
using machine vision to analyze the RW object.

20. The method of claim 15, wherein the RW object lacks electronic communication capability.
